(19) United States
(12) Patent Application Publication
(10) Pub. No.: US 2026/0105634 A1
(43) Pub. Date: Apr. 16, 2026

(54) METHOD AND APPARATUS FOR OBJECT POSE ESTIMATION

(71) Applicant: Electronics and Telecommunications Research Institute, Daejeon (KR)

(72) Inventors: Kap Kee KIM, Daejeon (KR); Bonki KOO, Daejeon (KR)

(73) Assignee: Electronics and Telecommunications Research Institute, Daejeon (KR)

(21) Appl. No.: 19/343,761

(22) Filed: Sep. 29, 2025

(30) Foreign Application Priority Data
Oct. 10, 2024 (KR) 10-2024-0138071

(51) Int. Cl. G06T 7/73; G06V 10/764; G06V 10/82

(52) U.S. Cl. CPC G06T 7/75; G06V 10/764; G06V 10/82; G06T 2207/20084

(57) ABSTRACT

A method for estimating object poses by a device may comprise acquiring object information for each of one or more objects in an input 2-dimensional (2D) image; and estimating the pose value of the object based on the 2D image and the object information using a pre-trained neural network model.

### CROSS-REFERENCE TO RELATED APPLICATIONS

This application claims priority to Korean Patent Application No. 10-2024-0138071, filed on October 10, 2024, with the Korean Intellectual Property Office (KIPO), the entire contents of which are hereby incorporated by reference.

### BACKGROUND

### 1. Technical Field

This disclosure relates to a method for estimating the pose of an object, and more particularly, to an object pose estimation method and device capable of estimating the pose of an object by using a single neural network model to estimate the pose value of the object extracted from a 2-dimensional (2D) image.

### 2. Related Art

In order to align a 3-dimensional (3D) object with a 2D image, the object must be extracted from the 2D image and transformed into a 3D model. This transformation of the object into a 3D model may require 3D information about the object, such as its shape and pose.

Various methods have been explored to extract 3D information from 2D image objects, and recent advancements in artificial intelligence technology have led to research on methods using neural network models to extract 3D information about objects.

Traditional methods for extracting 3D information using neural network models involve estimating object pose information through classification or regression models. Initially, a classification model estimates the main pose values, followed by a regression model that assesses the difference between the estimated values and the object's actual pose values, allowing for the determination of the final pose value based on these two estimates.

However, the final estimation error in this conventional method is determined by the sum of the errors from both models, which can lead to increased estimation errors for object pose information using the neural network model. This increase may degrade the performance of the neural network, resulting in lower accuracy in pose estimation needed for the transformation of the object into a 3D model.

### SUMMARY

This disclosure has been conceived to solve the above problem and it is an object of this disclosure to provide an object pose estimation method and device capable of estimating object pose using a single neural network model.

According to a first exemplary embodiment of the present disclosure, a method for estimating object poses by a device may comprise: acquiring object information for each of one or more objects in an input 2-dimensional (2D) image; and estimating the pose value of the object based on the 2D image and the object information using a pre-trained neural network model.

The estimating of the pose value of the object may comprise: acquiring a single object class from a plurality of object classes based on the object information; acquiring a single main rotation value from a plurality of main rotation values of the single object class based on the object information; acquiring one or more rotation difference values for the single main rotation value; and estimating the object pose value by summing the single main rotation value and the one or more rotation difference values.

The object information may comprise object class information, and the acquiring of the single object class may comprise: selecting a single object class corresponding to the object class information from the plurality of object classes.

Each of the plurality of main rotation values may comprise a rotation similarity value, and the acquiring of the single main rotation value may comprise: acquiring the single main rotation value that has the maximum similarity rotation value to the object information from among the rotation similarity values of each of the plurality of main rotation values.

Each of the plurality of main rotation values may comprise a plurality of element values in quaternion form, and the one or more rotation difference values may be a rotation value having a difference in at least one element value of the plurality of element values of the single main rotation value.

The acquiring of the object information may comprise: acquiring an encoded image of the 2D image; generating a mask corresponding to each of one or more object regions in the encoded image; and extracting the object from the encoded image using the mask and acquiring the object information for the extracted object, wherein the object information may comprise at least one of object mask image information, object class information, or object bounding box information.

The neural network model may be trained to estimate the pose value of the object upon receiving the actual pose value of the object as label data along with the 2D image and the object information.

The neural network model may be trained to estimate the pose value of the object by determining an estimation loss value based on the difference between the estimated pose value of the object and the actual pose value, and adjusting one or more internal parameter values to minimize the estimation loss value.

According to a second exemplary embodiment of the present disclosure, an object pose estimation device may comprise: at least one processor configured to operate the object pose estimation device to acquire object information for each of one or more objects in an input 2-dimensional (2D) image, and estimate the pose value of the object based on the 2D image and the object information using a pre-trained neural network model.

The at least one processor may operate the object pose estimation device to acquire a single object class from a plurality of object classes based on the object information, acquire a single main rotation value from a plurality of main rotation values of the single object class based on the object information, acquire one or more rotation difference values for the single main rotation value, and estimate the object pose value by summing the single main rotation value and the one or more rotation difference values.

The object information may comprise object class information, and the at least one processor may operate the object pose estimation device to select a single object class corresponding to the object class information from the plurality of object classes.

Each of the plurality of main rotation values may comprise a rotation similarity value, and the at least one processor may operate the object pose estimation device to acquire the single main rotation value that has the maximum similarity rotation value to the object information from among the rotation similarity values of each of the plurality of main rotation values.

Each of the plurality of main rotation values may comprise a plurality of element values in quaternion form, and the one or more rotation difference values may be a rotation value having a difference in at least one element value of the plurality of element values of the single main rotation value.

The at least one processor may operate the object pose estimation device to acquire an encoded image of the 2D image, generate a mask corresponding to each of one or more object regions in the encoded image, extract the object from the encoded image using the mask, and acquire object information for the extracted object.

The object information may comprise at least one of object mask image information, object class information, or object bounding box information.

The neural network model may be trained to estimate the pose value of the object upon receiving the actual pose value of the object as label data along with the 2D image and the object information.

The neural network model may be trained to estimate the pose value of the object by determining an estimation loss value based on the difference between the estimated pose value of the object and the actual pose value, and adjusting one or more internal parameter values to minimize the estimation loss value.

The disclosed object pose estimation device is advantageous in terms of estimating pose values for an object from a 2D image using a pre-trained single neural network model. This helps prevent an increase in estimation errors associated with the object pose estimation performed by the neural network model, thereby enhancing the model's learning performance and improving the accuracy of object pose estimation based on the neural network model.

### BRIEF DESCRIPTION OF DRAWINGS

FIG. 1 is a block diagram illustrating an object pose estimation device.

FIG. 2 is a conceptual diagram illustrating the functionality of the pose estimation program.

FIG. 3 is a conceptual diagram illustrating at least part of the operation of the object pose estimation module.

FIG. 4 is a conceptual diagram illustrating the learning method for the object pose estimation module.

FIG. 5 is a flowchart illustrating an object pose estimation method.

FIG. 6 is a flowchart illustrating a method for acquiring object information.

FIG. 7 is a flowchart illustrating a method for estimating object pose values.

FIG. 8 is a block diagram illustrating an image matching device including the object pose estimation module.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

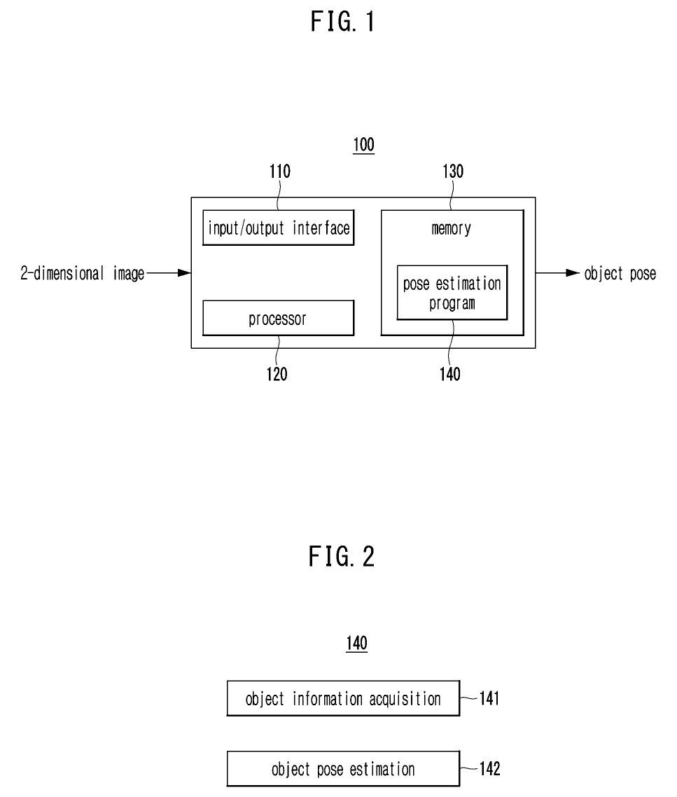

FIG. 1 is a block diagram illustrating an object pose estimation device.

With reference to FIG. 1, the object pose estimation device 100 according to this embodiment may include an input/output interface unit 110, a processor 120, and a memory 130.

The input/output interface unit 110 may receive a 2D image from the outside. Here, the 2D image may contain one or more objects.

The input/output interface unit 110 may output the estimated object pose values provided by the processor 120 to an external device, such as an image alignment device (not shown) configured to align a 3D model with the 2D image.

The processor 120 may control the overall operation of the object pose estimation device 100. For example, the processor 120 may control the operation of the object pose estimation device 100 to estimate and output the object pose values for each of the one or more objects in the 2D image provided through the input/output interface unit 110 using a pose estimation program 140 stored in the memory 130.

Here, the object pose value may represent a rotation value indicating a 3D rotation of the object. This object pose value may take the form of a quaternion consisting of a plurality of element values, for example, three rotation axis vector element values and one rotation angle element value.

The memory 130 may store the pose estimation program 140 and the information necessary for its execution. The pose estimation program 140 may be software containing instructions to extract one or more objects from the 2D image to obtain object information and to estimate object pose values based on the obtained object information.

Thus, when the 2D image is received through the input/output interface unit 110, the processor 120 may execute the pose estimation program 140 to acquire object information for each of the one or more objects in the 2D image, estimate the object pose values for each object, and output these values to the outside through the input/output interface unit 110.

FIG. 2 is a conceptual diagram illustrating the functionality of the pose estimation program.

With reference to FIG. 2, the pose estimation program 140 according to this embodiment may include an object information acquisition module 141 and an object pose estimation module 142.

The object information acquisition module 141 and the object pose estimation module 142, as shown in FIG. 2, are divided to simply the explanation of the functionality of the pose estimation program 140, but this disclosure is not limited to this configuration. For example, the functions of the object information acquisition module 141 and the object pose estimation module 142 may be merged or separated, and they may consist of a series of instructions included in a single program.

The object information acquisition module 141 may acquire object information for each of the one or more objects from the 2D image received by the input/output interface unit 110.

The object information acquisition module 141 may encode the 2D image. The object information acquisition module 141 may generate a mask corresponding to the object region where one or more objects are located in the encoded image. Using the mask, the object information acquisition module 141 may extract the object from the encoded image and acquire object information based on the extracted object and the encoded image. Here, the object information may include at least one of object mask image information, object class information, or object bounding box information.

The object information acquisition module 141 may acquire object information using a segmentation algorithm, such as the Mask R-CNN algorithm, capable of extracting objects from the 2D image at the pixel level when the 2D image is input.

The object pose estimation module 142 may receive the object information acquired by the object information acquisition module 141 and the 2D image as input. From the object information and the 2D image, the object pose estimation module 142 may estimate the pose value of the object, such as the object rotation value, within the 2D image.

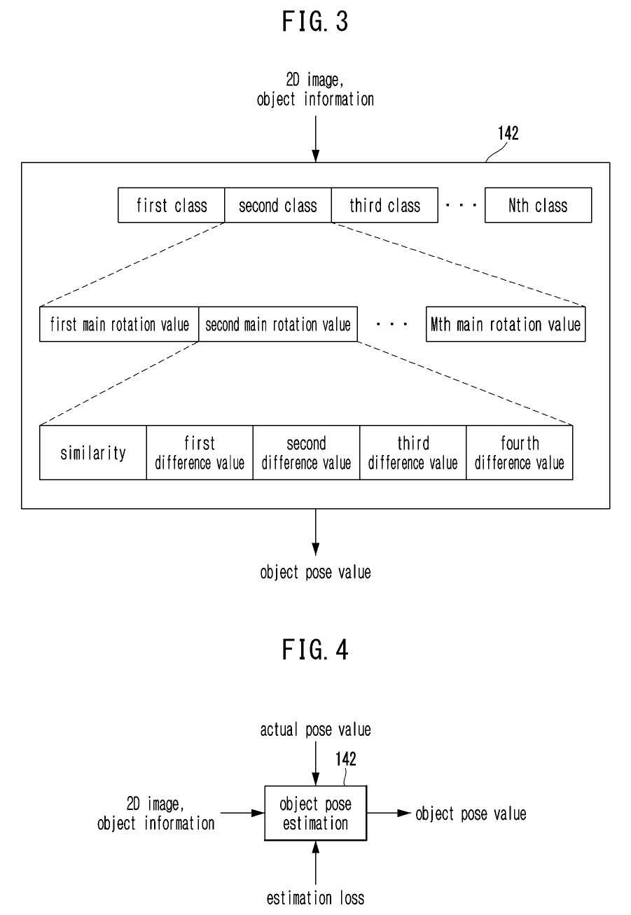

FIG. 3 is a conceptual diagram illustrating at least part of the operation of the object pose estimation module 142.

The object pose estimation module 142 may receive a2D image and object information as input. Here, the 2D image may contain one or more objects, and the object information may include at least one of object mask image information, object class information, or object bounding box information, which has been extracted from the 2D image.

The object pose estimation module 142 may acquire a single object class corresponding to the object class information from among a plurality of object classes. As mentioned above, the object information may be derived from objects located within the 2D image. The object pose estimation module 142 may select a single object class, to which the object belongs, from among the plurality of object classes based on the object information.

Each of the plurality of object classes may include a plurality of main rotation values. Here, the main rotation value may be in the form of a quaternion, composed of three rotation axis vector elements and one rotation angle element (for example, an origin quaternion, a medoid quaternion, and so on). Each of the plurality of main rotation values may have at least one differing element among the four aforementioned elements.

Each of the main rotation values may include a rotation similarity value. The rotation similarity value may represent the similarity, such as a cosine similarity value, between the shape of the object based on the main rotation value and the shape of the object according to the bounding box in the object information. This rotation similarity value may range from 0 to 1, where a value closer to 0 indicates that the object shape corresponding to the main rotation value is dissimilar to the object information, and a value closer to 1 indicates that the object shape is similar to the object information.

Additionally, each of the main rotation values may include one or more rotation difference values. The rotation difference value may also be in quaternion form, composed of three rotation axis vector elements and one rotation angle element (for example, a delta quaternion). This rotation difference value may represent a rotation value that differs in at least one of the four elements of the aforementioned main rotation value.

The object pose estimation module 142 may obtain a single main rotation value that has the highest similarity to the object information based on the rotation similarity values of a plurality of main rotation values of a single object class acquired from the object information. Additionally, the object pose estimation module 142 may obtain one or more rotation difference values for the acquired single main rotation value.

The object pose estimation module 142 may estimate the rotation value of the object, or in other words, the object pose value, based on the main rotation value and the one or more rotation difference values. The object pose estimation module 142 may estimate the object pose value by summing the main rotation value and the one or more rotation difference values.

The object pose estimation module 142 may be a neural network model trained through deep learning or machine learning to estimate object pose values using a plurality of training data.

For example, when the number of classes represented in the plurality of classes depicted in FIG. 3 is denoted as N, the object pose estimation module 142 according to an embodiment of this disclosure may directly determine the class using the result value of the object information acquisition module 141.

In the object pose estimation module 142 according to an embodiment of this disclosure, there may be M main rotation values for each class, as shown in FIG. 3.

The main rotation values may be represented as quaternions, referring to the rotation poses in which the class is primarily located in the observed image, and may be stored and managed in a table through prior observations.

Each of the similarity, first difference value, second difference value, and fourth difference value may correspond to a single float value. The similarity may be selected as the maximum value among the first to M^{th} main rotation values. The difference values represent the differences in quaternions and may refer to differences from the main rotation value.

In the configuration of FIG. 3, the difference values may be reflected in the main rotation values to obtain the final rotation value.

The result inferred from the object rotation pose value through the inference network depicted in FIG. 3 may be implemented as NxMx5 float values.

The object pose value obtained based on the main rotation values and one or more rotation difference values through the process shown in FIG. 3 may be the object's rotation value. In the operation of the object pose estimation module 142 according to an embodiment of this disclosure, the object rotation value and the object translation value may be summed to obtain the object pose value.

In an embodiment of this disclosure, the object pose estimation module 142 may include an object translation pose value inference network and an object rotation pose value inference network. FIG. 3 illustrates an embodiment of the object rotation pose value inference network.

In an embodiment of this disclosure, the object translation pose value inference network may operate in parallel with the object rotation pose value inference network. The object rotation pose value and object translation pose value obtained in this manner may be summed to derive the final object pose value.

FIG. 4 is a conceptual diagram illustrating the learning method for the object pose estimation unit.

With reference to FIG. 4, the object pose estimation module 142 may receive a 2D image containing the object and object information related to the object as input training data. As described above, the object information may include at least one of object mask image information, object class information, or object bounding box information, which are obtained by the object information acquisition module 141 from the 2D image. Additionally, the object pose estimation module 142 may receive the actual pose value of the object as label data, along with the 2D image and object information.

The object pose estimation module 142 may estimate the object pose value from the training data. The object pose estimation module 142 may also compare the estimated object pose value with the label data and determine the estimation loss value based on the difference. The object pose estimation module 142 may adjust one or more internal parameter values to minimize the determined estimation loss value while repeatedly performing the aforementioned training, i.e., training to estimate the object pose value by receiving inputs of the 2D image and object information.

Meanwhile, according to an embodiment of this disclosure, the object pose estimation module 142 may include the aforementioned object information acquisition module 141. Thus, the object pose estimation module 142 may receive a 2D image containing one or more objects as training data, acquire object information from the 2D image, and be trained to estimate the object pose value based on the obtained object information.

As described above, the object pose estimation device 100 of this disclosure may estimate the pose value of the object included in the 2D image using a pre-trained single neural network model, i.e., the object pose estimation module 142. Therefore, this disclosure helps prevent an increase in the object pose estimation error of the neural network model, enhancing its learning performance and improving the accuracy of object pose estimation.

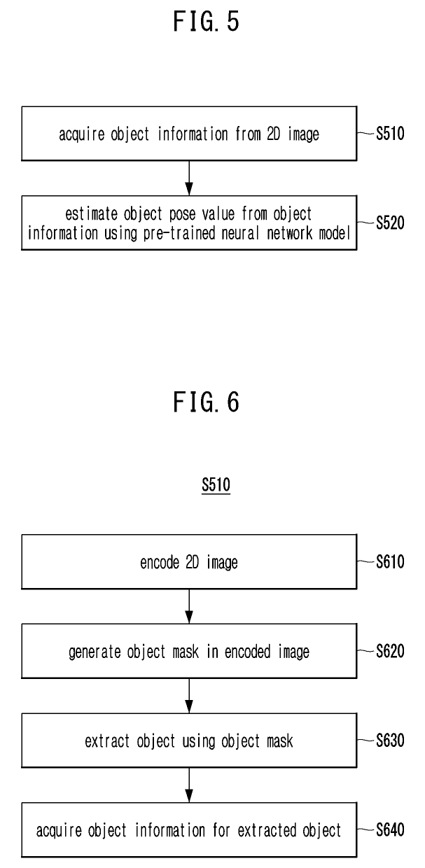

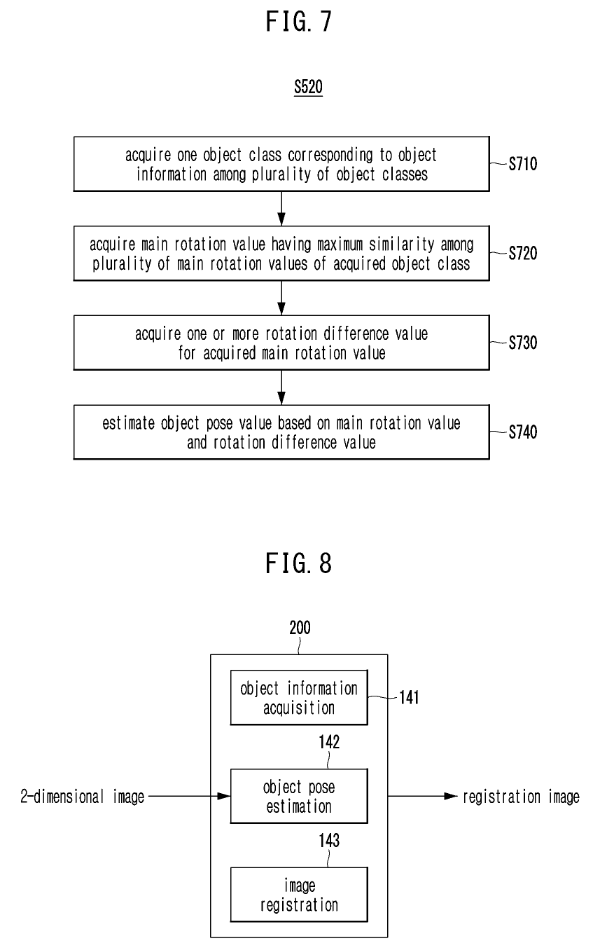

FIG. 5 is a flowchart illustrating an object pose estimation method, FIG. 6 is a flowchart illustrating a method for acquiring object information, and FIG. 7 is a flowchart illustrating a method for estimating object pose values.

With reference to FIG. 5, the object pose estimation method according to this disclosure may include acquiring, in operation S510, object information for each of one or more objects in a 2D image input from the outside, and estimating, in operation S520, the pose value of the corresponding object from the object information using a pre-trained neural network model.

With reference to FIG. 6, the object pose estimation device 100 may receive a 2D image containing one or more objects through the input/output interface unit 110. The processor 120 of the object pose estimation device 100 may execute a pose estimation program 140 stored in memory 130.

The object information acquisition module 141 may encode the 2D image provided through the input/output interface unit 110. In operation S610, the object information acquisition module 141 may output an encoded image of the 2D image.

In operation S620, the object information acquisition module 141 may generate an object mask corresponding to the area where the object is located in the encoded image. Here, the object mask may be generated at the pixel level in the encoded image.

In operation S630, the object information acquisition module 141 may extract one or more objects from the encoded image using the generated object mask, and in operation S640, may acquire object information for each extracted object. Here, the object information may include at least one of the object mask image information, object class information, or object bounding box information for each object.

With reference to FIG. 7, the object pose estimation module 142 may receive object information from the object information acquisition module 141. The object pose estimation module 142 may estimate the pose value of the object based on the 2D image and object information.

In operation S710, the object pose estimation module 142 may acquire one object class corresponding to the object class information of the object information among a plurality of object classes.

In operation S720, the object pose estimation module 142 may acquire one main rotation value that has the maximum similarity with the object information based on the rotation similarity values of a plurality of main rotation values of the one object class acquired based on the object information.

In operation S730, the object pose estimation module 142 may acquire one or more rotation difference values for the one main rotation value obtained.

In operation S740, the object pose estimation module 142 may estimate the pose value of the object based on the main rotation value and one or more rotation difference values (S740). The object pose estimation module 142 may estimate the object pose value by summing the main rotation value and the one or more rotation difference values.

FIG. 8 is a block diagram illustrating an image matching device including the object pose estimation unit.

With reference to FIG. 8, the image matching device 200 may include the object information acquisition module 141, the object pose estimation module 142, and the image matching module 143.

The object information acquisition module 141 and the object pose estimation module 142 may estimate the pose values of one or more objects in the 2D image, and they may perform functions that are substantially identical to those of the object information acquisition module 141 and the object pose estimation module 142 of the object pose estimation device 100 as described with reference to FIGS. 1 and 2.

The object information acquisition module 141 may encode the 2D image and acquire object information for each of one or more objects from the encoded image. The object information may include at least one of the object mask image information, object class information, or object bounding box information.

The object pose estimation module 142 may be a pre-trained neural network model and may estimate the pose value of the object from the 2D image and the object information acquired by the object information acquisition module 141. The object pose estimation module 142 may acquire one object class corresponding to the object class information of the object information among a plurality of object classes, and may acquire one main rotation value that has the maximum similarity with the object information and one or more rotation difference values for the one main rotation value among a plurality of main rotation values of the acquired object class. The object pose estimation module 142 may estimate the pose value of the object from the obtained main rotation value and rotation difference values.

The image matching module 143 may generate a 3D model of the object in the 2D image based on the estimated object pose value. The image matching module 143 may generate a matched image by matching the 3D model of the object with the 2D image.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for estimating object poses by an apparatus, the method comprising:
acquiring object information for each of one or more objects in an input 2-dimensional (2D) image; and
estimating the pose value of the object based on the 2D image and the object information using a pre-trained neural network model.

2. The method of claim 1, wherein the estimating of the pose value of the object comprises:
acquiring a single object class from a plurality of object classes based on the object information;
acquiring a single main rotation value from a plurality of main rotation values of the single object class based on the object information;
acquiring one or more rotation difference values for the single main rotation value; and
estimating the object pose value by summing the single main rotation value and the one or more rotation difference values.

3. The method of claim 2, wherein the object information comprises object class information, and the acquiring of the single object class comprises selecting a single object class corresponding to the object class information from the plurality of object classes.

4. The method of claim 2, wherein each of the plurality of main rotation values comprises a rotation similarity value, and the acquiring of the single main rotation value comprises acquiring the single main rotation value that has the maximum similarity rotation value to the object information from among the rotation similarity values of each of the plurality of main rotation values.

5. The method of claim 2, wherein each of the plurality of main rotation values comprises a plurality of element values in quaternion form, and the one or more rotation difference values is a rotation value having a difference in at least one element value of the plurality of element values of the single main rotation value.

6. The method of claim 1, wherein the acquiring of the object information comprises:
acquiring an encoded image of the 2D image;
generating a mask corresponding to each of one or more object regions in the encoded image; and
extracting the object from the encoded image using the mask and acquiring the object information for the extracted object,
wherein the object information comprises at least one of object mask image information, object class information, or object bounding box information.

7. The method of claim 1, wherein the neural network model is trained to estimate the pose value of the object upon receiving the actual pose value of the object as label data along with the 2D image and the object information.

8. The method of claim 7, wherein the neural network model is trained to estimate the pose value of the object by determining an estimation loss value based on the difference between the estimated pose value of the object and the actual pose value, and adjusting one or more internal parameter values to minimize the estimation loss value.

9. An object pose estimation apparatus comprising:
at least one processor configured to:
operate the object pose estimation apparatus to acquire object information for each of one or more objects in an input 2-dimensional (2D) image, and
estimate the pose value of the object based on the 2D image and the object information using a pre-trained neural network model.

10. The object pose estimation apparatus of claim 9, wherein the at least one processor is further configured to:
operate the object pose estimation apparatus to acquire a single object class from a plurality of object classes based on the object information, acquire a single main rotation value from a plurality of main rotation values of the single object class based on the object information, acquire one or more rotation difference values for the single main rotation value, and estimate the object pose value by summing the single main rotation value and the one or more rotation difference values.

11. The object pose estimation apparatus of claim 10, wherein the object information comprises object class information, and the at least one processor operates the object pose estimation apparatus to select a single object class corresponding to the object class information from the plurality of object classes.

12. The object pose estimation apparatus of claim 10, wherein each of the plurality of main rotation values comprises a rotation similarity value, and the at least one processor operates the object pose estimation apparatus to acquire the single main rotation value that has the maximum similarity rotation value to the object information from among the rotation similarity values of each of the plurality of main rotation values.

13. The object pose estimation apparatus of claim 10, wherein each of the plurality of main rotation values comprises a plurality of element values in quaternion form, and the one or more rotation difference values is a rotation value having a difference in at least one element value of the plurality of element values of the single main rotation value.

14. The object pose estimation apparatus of claim 9, wherein the at least one processor operates the object pose estimation apparatus to acquire an encoded image of the 2D image, generate a mask corresponding to each of one or more object regions in the encoded image, extract the object from the encoded image using the mask, and acquire object information for the extracted object.

15. The object pose estimation apparatus of claim 9, wherein the object information comprises at least one of object mask image information, object class information, or object bounding box information.

16. The object pose estimation apparatus of claim 9, wherein the neural network model is trained to estimate the pose value of the object upon receiving the actual pose value of the object as label data along with the 2D image and the object information.

17. The object pose estimation apparatus of claim 16, wherein the neural network model is trained to estimate the pose value of the object by determining an estimation loss value based on the difference between the estimated pose value of the object and the actual pose value, and adjusting one or more internal parameter values to minimize the estimation loss value.
